(19) United States
(12) Patent Application Publication
(10) Pub. No.: US 2024/0087550 A1
(43) Pub. Date: Mar. 14, 2024

(54) PERFORMANCE DATA TRANSMISSION CONTROL METHOD, STORAGE MEDIUM, ELECTRONIC DEVICE AND ELECTRONIC MUSICAL INSTRUMENT

(71) Applicant: CASIO COMPUTER CO., LTD., Tokyo (JP)

(72) Inventor: Jun SATO, Tokyo (JP)

(73) Assignee: CASIO COMPUTER CO., LTD., Tokyo (JP)

(21) Appl. No.: 18/466,785

(22) Filed: Sep. 13, 2023

(30) Foreign Application Priority Data
Sep. 14, 2022 (JP) 2022-145744

(51) Int. Cl. G10H 1/043

(52) U.S. Cl. CPC G10H 1/043; G10H 2210/325

(57) ABSTRACT

A method for performance data transmission control executed by one or more processors includes receiving performance data associated with output timings, the performance data including continuously varying operation data whose value changes continuously; detecting characteristic points of change from the continuously varying operation data; thinning out the continuously varying operation data other than the characteristic points of the change; and generating unit performance data to be transmitted to an external device, based on the performance data in which the characteristic points in the continuously varying operation data have been detected and in which the continuously varying operation data other than the characteristic points have been thinned out.

### BACKGROUND OF THE INVENTION

### Technical Field

The present invention relates to a performance data transmission control method, a storage medium, an electronic device, and an electronic musical instrument therefor.

### Description of Related Art

Conventionally, MIDI (Musical Instrument Digital Interface) data has been widely used as performance data that defines the contents of electronic performances. Bluetooth (registered trademark) or the like is known as a wireless communication standard capable of transmitting MIDI data to an audio output unit that decodes MIDI data and generates an audio signal.

In transmission and reception of MIDI data according to a communication standard with insufficient communication speed, when the amount of data is remarkably large, real-time audio signal output from the receiving device may be hindered. On the other hand, there is a technique for reducing the amount of data by thinning out transmission data at an appropriate rate according to conditions such as frequency of types of performance content that tends to increase the amount of data (Patent Document 1).
Patent Document 1: Japanese Patent Application Laid-Open Publication No. 2005-221788

### SUMMARY OF THE INVENTION

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a method for performance data transmission control executed by one or more processors, the method comprising, via the one or more processors: receiving performance data associated with output timings, the performance data including continuously varying operation data whose value changes continuously; detecting characteristic points of change from the continuously varying operation data; thinning out the continuously varying operation data other than the characteristic points of the change; and generating unit performance data to be transmitted to an external device, based on the performance data in which the characteristic points in the continuously varying operation data have been detected and in which the continuously varying operation data other than the characteristic points have been thinned out.

In another aspect, the present disclosure provides a non-transitory computer-readable storage medium storing a program executable by one or more processors, the program causing the one or more processors to perform the following: receiving performance data associated with output timings, the performance data including continuously varying operation data whose value changes continuously; detecting characteristic points of change from the continuously varying operation data; thinning out the continuously varying operation data other than the characteristic points of the change; and generating unit performance data to be transmitted to an external device, based on the performance data in which the characteristic points in the continuously varying operation data have been detected and in which the continuously varying operation data other than the characteristic points have been thinned out.

In another aspect, the present disclosure provides an electronic device, comprising: a transmission unit; and at least one processor configured to perform the following: receiving performance data associated with output timings, the performance data including continuously varying operation data whose value changes continuously; detecting characteristic points of change from the continuously varying operation data; thinning out the continuously varying operation data other than the characteristic points of the change; and generating unit performance data to be transmitted through by the transmission unit to an external device, based on the performance data in which the characteristic points in the continuously varying operation data have been detected and in which the continuously varying operation data other than the characteristic points have been thinned out.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a block diagram showing the functional configuration of an electronic device.

FIG. 2 is a diagram for explaining setting of data to be retained and data to be thinned.

FIG. 3 is a diagram showing an example of data thinning.

FIG. 4 is a diagram for explaining window setting of the LPF (low pass filter).

FIG. 5 is a flow chart showing the control procedure of the performance data output control process.

### DETAILED DESCRIPTION OF EMBODIMENTS

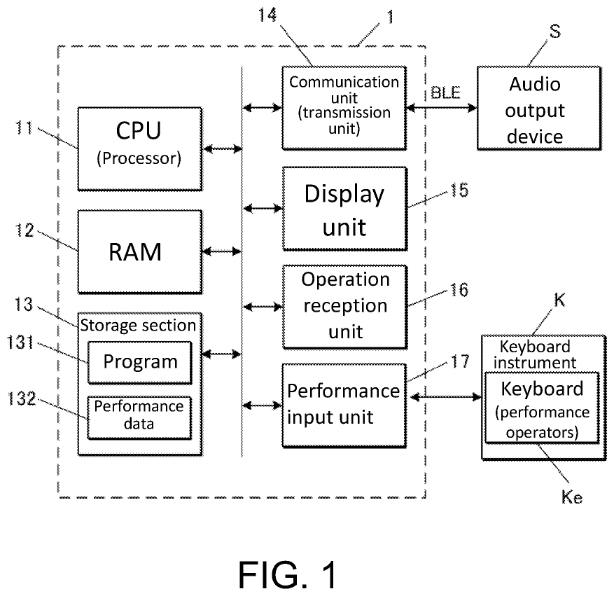

Embodiments of the present invention will be described below with reference to the drawings. FIG. 1 is a block diagram showing the functional configuration of an electronic device 1 of this embodiment. The electronic device 1 includes a computer that generates or acquires performance data (MIDI data), stores and outputs the data. The computer may be a normal PC (Personal Computer), a tablet terminal, a smart phone, or the like. Alternatively, the electronic device 1 may be an electronic musical instrument having a keyboard Ke (performance operators), as will be described later. The performance data may be generated by the user using MIDI software on the screen, or by playing a musical instrument. Alternatively, these operations may be used together to generate performance data.

The electronic device 1 includes a CPU 11 (Central Processing Unit), a RAM 12 (Random Access Memory), a storage unit 13, a communication unit 14 (transmission unit), a display unit 15, an operation reception unit 16, and a performance input unit 17, etc. These elements are electrically connected to each other via a bus.

The CPU 11 is a processor that performs arithmetic processing and centrally controls the operation of the electronic device 1. The CPU 11 may be designed suitably for controlling the generation of audio output data. The CPU 11 may have a single processor, or a plurality of processors may operate in parallel or independently depending on the application. The CPU 11 also counts the current time based on a clock signal output by an oscillation circuit (not shown). For this purpose, the electronic device 1 includes an unillustrated RTC (Real Time Clock). The CPU 11 acquires the current time from the RTC when the electronic device 1 is activated.

The RAM 12 provides a working memory space for the CPU 11 and stores temporary data.

The storage unit 13 is a nonvolatile memory such as a flash memory or an HDD. The storage unit 13 stores a program 131 for generating audio output data, setting data, and performance data 132 (MIDI data).

The communication unit 14 controls communication operations with an external device such as the audio output device S according to a defined communication standard. Communication standards that can be used by the communication unit 14 include the Low Energy Standard of Bluetooth (BLE; a registered trademark together with Bluetooth). The audio output device S may be a synthesizer specialized for audio output, or a general-purpose computer installed with software capable of converting MIDI data into an audio signal and outputting the audio signal. A communication module that controls communication based on BLE may be connected to the connection terminal of the communication unit 14 as a peripheral device.

The display unit 15 has a display screen, and displays a status, a MIDI setting reception screen, etc., on the display screen based on the control by the CPU 11. The display screen is, for example, a liquid crystal display screen (LCD), but is not limited to this. The operation reception unit 16 receives an operation from the outside such as a user and outputs an operation signal to the CPU 11 according to the content of the reception. The operation reception unit 16 has operation buttons, a keyboard, a pointing device, and the like. Alternatively, the operation reception unit 16 may have a touch panel that overlaps the display screen. The operation buttons include a power switch for turning on/off power supply. The keyboard and the pointing device may be peripheral devices attached to the communication unit 14 instead of being built in the electronic device 1.

The performance input unit 17 has an input terminal for receiving data (MIDI data) related to a performance using a keyboard Ke of an electronic musical instrument (for example, a keyboard device K) and operation receiving units (performance operators) such as a pitch bender and a modulation wheel. The input terminal is not limited to MIDI input terminals. The input terminal may be, for example, a general USB terminal as long as it can input a digital signal. Digital data input to the input terminal is output to the CPU 11 and RAM 12 as it is. Alternatively, the electronic device 1 may include a keyboard Ke for generating MIDI data according to performance operations. Alternatively, the electronic device 1 may receive analog signal (waveform) data and the CPU 11 may convert it into MIDI data. Conversion to MIDI data may be performed by a dedicated circuit (a processor separate from the CPU 11) such as a DSP (Digital Signal Processor). Also, the input terminals of the performance input unit 17 may be the same as general-purpose input/output terminals provided in the communication unit 14 and may be used in common.

Next, the output of MIDI data will be described. The MIDI data includes information indicating the content of the sound to be output (pitch, timbre, volume, effect to be applied, etc.) and its output timing. The MIDI data is output to the audio output device S and converted into an audio signal. The audio output device S sends the audio signal to a speaker, an earphone output, or the like so as to output audio according to the content of the MIDI data. Note that the audio output device S may be capable of adding effects desired by the user.

The electronic device 1 can transmit MIDI data to the audio output device S (external device) by BLE (wireless communication). In BLE, MIDI data is sequentially transmitted in units of packets transmitted at specified communication intervals (certain time intervals). The communication interval can be variably set within the range defined by the BLE standard, but is often fixed (for example, 15 msec interval). In this embodiment, it is assumed that packet data is transmitted and received at uniform communication intervals. The data format of the communication content may conform to a common standard (MIDI over Bluetooth Low Energy). A packet includes a plurality of pieces of data (unit performance data) in which the information (message) of the contents of the audio output is associated with the information (time stamp) of the output timing, as described above. The associated output timing may be the same or close with respect to a plurality of messages as long as the DSP can process them in parallel. Note that when different processes of the same type are associated with the same timing, only the last data may be executed within the same timing.

Transmission and reception of performance data using BLE is convenient because there is no need to connect the electronic device 1 and an external device with a cable. On the other hand, there is an upper limit to the size of data that can be transmitted in each packet, depending on the data transfer speed of BLE. Therefore, if there are a large number of sound content settings (messages) to be output within the packet data transmission interval, the amount of data corresponding to the content settings exceeds the upper limit (maximum data size), and all of these may not be included in a packet. If all the necessary contents are not received and acquired by the timing of outputting the sound, the audio output device S cannot properly output the sound. Specific examples of the types of operations related to performances that require a significantly large amount of data include those involving continuous changes in pitch, such as pitch bend, modulation, and aftertouch. In terms of musical notation, continuous pitch changes include those that do not generally express intermediate tones with notes, such as glissando, portamento, bends, and the like.

Further, the types of operations related to other performances, which require a significantly large amount of data, may include continuous changes in volume. Performances related to volume change include, for example, expression, panpot related to sound image localization, and breath control using a breath controller. The above-described aftertouch may also be performed with a change in volume.

In the data to be transmitted in each packet, when the performance of the type related to the operation in which the value changes continuously is set, the electronic device 1 causes some messages to be thinned out from the data (continuously varying operation data) corresponding to these operations, and are omitted from the transmission by BLE, to the extent the thinning does not cause significant deterioration in the quality of the performance. In order to suppress the deterioration of performance quality, the electronic device 1 determines messages to be omitted (continuously varying operation data) so as to preferentially retain characteristic sounds (characteristic points of changes) with respect to changes in values. In the case of messages related to pitch changes (pitch data), the characteristic sounds/points include, for example, extremum values of changing pitches, such as the first pitch, the last pitch, the lowest pitch, the highest pitch, and the peak (extremum) pitch where the pitch rises and falls. In addition, the characteristic sounds/points may include points of inflection of pitch changes (points where the acceleration of change becomes zero) and points where the speed of pitch remarkably changes (points where the acceleration of change greatly changes). Similarly, in the case of messages related to volume changes (volume data), the characteristic points may include extremum values of changing volume, points of inflection of volume change, points at which change acceleration greatly changes, and the like.

If there are messages that can be preferentially thinned out (removed) as opposed to these preferentially remained messages, those messages can be deleted in advance. For example, during the period when the pitch does not change during pitch bend (the amount of pitch change is below the reference), data other than the beginning and end (the change speed is zero before and after (the center difference is zero), or the change velocity and acceleration are both zero) may be preferentially removed.

After that, in the electronic device 1, the performance data are thinned out from continuously varying operation data (such as pitch data or volume data (“or” here does not have an exclusive meaning) at a thinning rate that leaves an appropriate ratio of data that can be included in the packet data such that the data other than the continuously varying operation data that is not targeted for thinning, the messages (characteristic points) that are preferentially left, and the remaining messages (pitch data or volume) other than the messages that are preferentially thinned out are retained. The thinning rate indicates the percentage of numbers of sampling points removed with respect to all the points of the continuously varying operation data (sample points) within the period. The messages to be removed may be evenly distributed (evenly spaced) at a defined ratio from the remaining messages. Alternatively, the messages to be removed may be determined so that the intervals between the retained messages, including the messages that are preferentially left, are as even as possible. Alternatively, a local thinning rate may be determined for each part according to the speed or acceleration of change in pitch or volume (state of change in pitch or volume). Also, the thinning rate may have an upper limit (maximum thinning rate). The upper limit is, for example, about 20% to 50%, although it depends on the situation. If the performance data 132 includes both continuously varying operation data relating to pitch and continuously varying operation data relating to volume, the thinning rates may be set for those data separately.

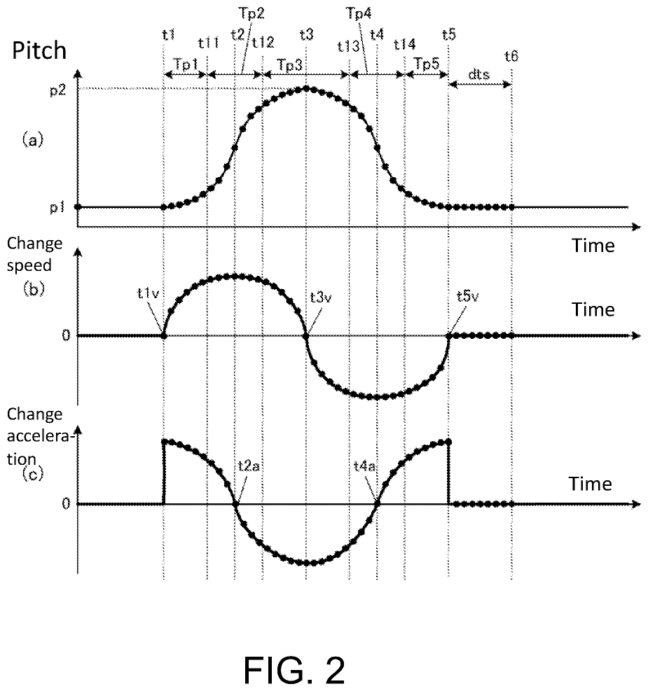

FIG. 2 is a diagram for explaining setting of data to be left and data to be thinned, showing examples in changes of pitch (a), pitch change speed (b), and pitch change acceleration (c), which are schematically indicated by curved lines and black circles in order from the top to the bottom with respect to the passage of time. Black circles indicate examples of timing of pitch data (sample points). The number and spacing of these black dots do not reflect the actual performance data 132. Although the number of pitch data may be much larger than the number of black circles according to the illustrated curve, here, it is assumed that only the black circle points are obtained pitch data.

As shown in pitch (a) in FIG. 2, timing t1 is the start timing of pitch bend, and at this timing t1, the pitch starts to rise from pitch p1. It rises to pitch p2 at timing t3. With this timing t3 as the apex, the pitch is switched to lowering, and at timing t5, the pitch returns to p1. During the period dts until timing t6, the same pitch p1 is maintained, after which the pitch bend ends.

As described above, the characteristic pitches include the pitch p1 at the timing t1 when the pitch bend starts, the pitch p2 at the timing t3 when the pitch is the highest, and the pitch p1 at the timing t5 when the pitch is the lowest. Also, the characteristic pitches may include the pitches at timings t2 and t4 of inflection points at which positive and negative of the pitch change acceleration are switched.

On the other hand, during the period dts in which the pitch does not change, except for the leading timing t5, even if the pitch bend data is deleted, it does not affect the output pitch. Therefore, the pitch data for that period can be preferentially omitted.

As shown in the change speed (b) shown in FIG. 2, at the timings t1 to t11 (first period Tp1), t12 to t3 to t13 (third period Tp3), and t14 to t5 (fifth period Tp5), the speed of change in pitch is smaller as compared with the timing t11 to t12 (second period Tp2) sandwiching timing t2 and the timing t13 to t14 (fourth period Tp4) sandwiching timing t4. In portions such as timings t11 to t12 and t13 to t14 where the speed of change in pitch is large, even if only one point is omitted, the change in pitch greatly increases. Therefore, in these parts, the thinning rate (the ratio of the number of sample points (pitch data) removed relative to all the sample points (pitch data) in the period) may be adjusted to be smaller than other parts so that discontinuous pitch changes are less likely to occur.

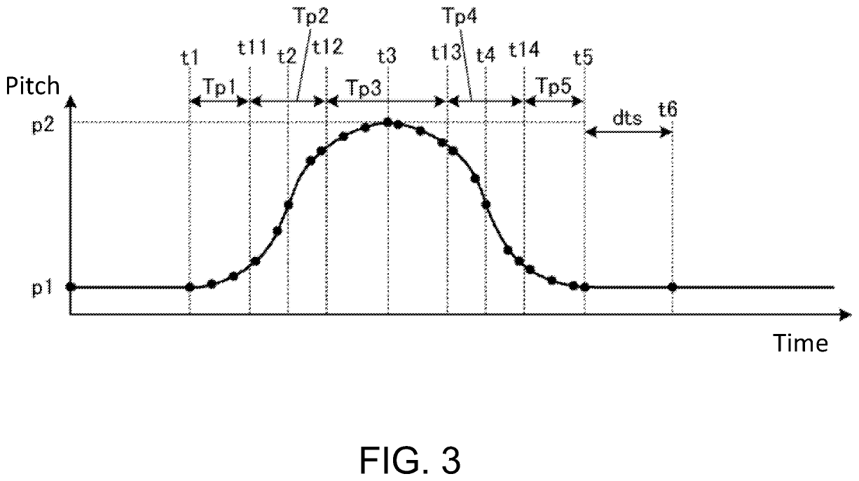

FIG. 3 shows an example of the data thinning. In this embodiment of the present invention, the sample point t1v (timing t1) immediately before the change speed changes from zero in (b) in FIG. 2; the sample points t3v and t5v (timings t3 and r5) at which the change speed becomes zero; and sample points t2a and t4a (timings t2 and t4) at which the change acceleration becomes zero in (c) of FIG. 2 (their pitch data) are all retained as characteristic points. The remaining sample points (pitch data) other than these timings may be thinned out by the appropriate thinning rate and/or thinning selection method as described above. Alternatively, depending on the amount of data, etc., all remaining sample points may be removed without considering the thinning rate.

In this embodiment, at timings t1411 (first period Tp1), t12-t13 (third period Tp3), t14-t5 (fifth period Tp5), etc., about a half or less of the pitch data (sample points) are thinned out (removed). That is, in these periods, the pitch data (sample points) are thinned out approximately every other time. On the other hand, at timings t11 to t12 (second period Tp2), t13 to t14 (fourth period Tp4), etc., the pitch data is only thinned out by approximately ⅓. This is because the amount of change in pitch per unit time for the timings t1-t11 (first period Tp1), t12-t13 (third period Tp3), and t14-t5 (fifth period Tp5) is small compared to that for the timings t11 to t12 (second period Tp2), t13 to t14 (fourth period Tp4), and so, even if many sample points are thinned out, it is considered that the sound quality of the generated musical tones is less affected. In the period dts, all data other than the first timing t5 and the last timing t6 are removed. That is, in this embodiment, the thinning method is adopted according to the characteristics/state of the sample data included in the period.

In another embodiment, a method of thinning sample data based on another concept may be employed. For example, at timings t11 to t12 (second period Tp2) and t13 to t14 (fourth period Tp4), etc., the speed change is small, and therefore the change in pitch is close to a straight line, whereas at timings the timings t1-t11 (first period Tp1), t12 to t3 to t13 (third period Tp3), and t14 to t5 (fifth period Tp5), the change in speed is large and the change in pitch largely deviates from straight lines. In such a non-linear change portion, even if one point is omitted, the pitch change pattern deviates from the original curve. Therefore, the thinning rate may be determined and adjusted depending on the respective portions to which the rate is applied, such as making the thinning rate in portions such as timings t1 to t11 (first period Tp1), t12 to t3 to t13 (third period Tp3), and t14 to t5 (fifth period Tp5) smaller than other portions.

The speed of change in pitch may be obtained based on the amount of change in pitch specified in a plurality of consecutive messages. For example, for the pitch p(i) in the i-th message, the amount of change may be obtained by the central difference (p(i+1)−p(i−1))/2 using the pitches p(i+1) and p(i−1) of the messages before and after. If the timing difference between messages is uneven, the difference value may be divided by the timing difference between these messages. Alternatively, it may be obtained by forward difference (p(i+1)−p(i)) or backward difference (p(i)−p(i−1)).

When modulations such as pitch bend in MIDI data are performed based on an actual performance, output noise or the like from the rotating wheel used for modulating pitch bend may occur. Due to such noise, fine fluctuations may be superimposed on the original pitch fluctuations. It is not preferable that a minute change or an extreme value of apparent pitch due to such noise is erroneously identified as a characteristic sound. Therefore, the electronic device 1 may apply a low-pass filter (LPF) to changes in pitch over a certain width (window size) to eliminate the effects of such minute changes. The size of the window may be set to, for example, about 1 to 2 times the packet transmission width.

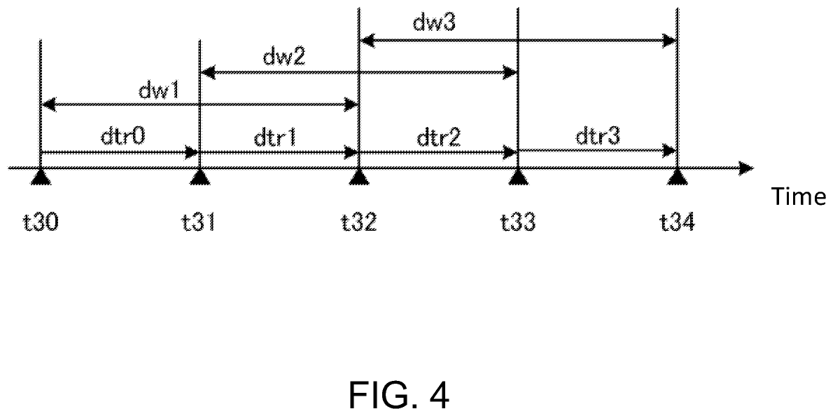

FIG. 4 is a diagram for explaining window setting of the LPF. Timings t30 to t34 indicate packet transmission timings. The periods dtr0 to dtr3 therebetween are equal to the packet transmission interval dtr and have the same length. For example, at timings t31 to t33, packets describing the contents of performances in the respectively subsequent periods dtr1 to dtr3 are transmitted, respectively. Alternatively, a performance-related message having the same length as the transmission interval dtr may be transmitted at timings delayed by a predetermined time from timings t31 to t33. Also, if the MIDI data (performance data 132) have been stored in advance in the storage unit 13, a message related to the performance prior to the corresponding period may be transmitted in advance depending on the amount of data being processed.

Here, when the packet data for period dtr1 is thinned out, for example, a range including period dtr1 and the preceding period dtr0 are determined as window dw1. Then, the LPF is applied to pitch changes in this window dw1. Similarly, in order to thin out some messages from the packet data for the period dtr2, the LPF may be applied to the change in pitch with the range including the period dtr2 and the preceding period dtr1 as the window dw2. Also, the application range of the LPF for packet data transmitted at timing t33 may be window dw3.

That is, in the electronic device 1, the sliding window for the LPF is defined such that each period is selected twice. Thereby, the window is always defined so that the end of the subsequent range to be transmitted is the end of the window. Therefore, even when MIDI data associated with a real-time performance or the like is input, the LPF can be applied without waiting for subsequent data. Therefore, the electronic device 1 can transmit and output MIDI data in substantially real time using BLE without causing unnecessary transmission delays.

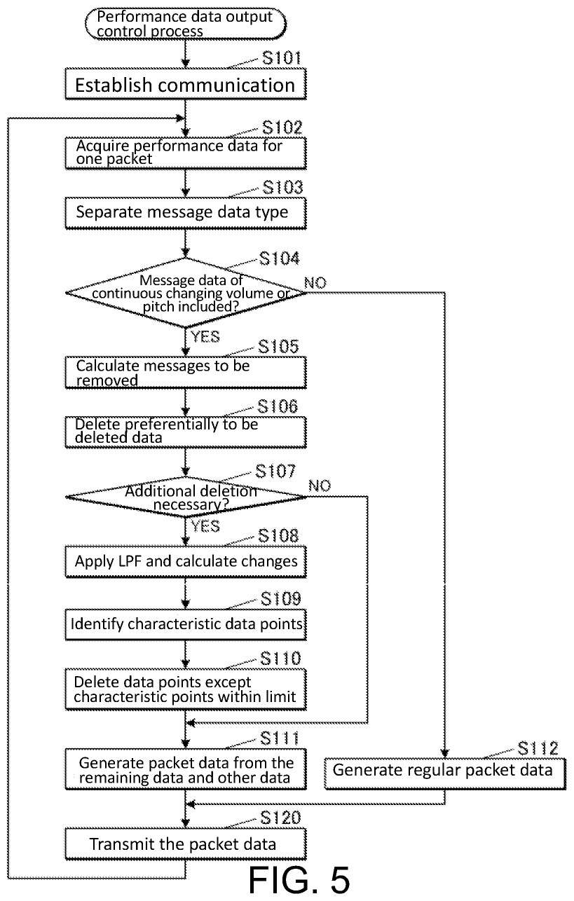

FIG. 5 is a flow chart showing the control procedure by the CPU 11 of the performance data output control process executed by the electronic device 1 of this embodiment. This processing including the performance data transmission control method of the present embodiment is automatically activated when, for example, performance data is accepted, and is continuously executed while the electronic device 1 is operating.

The CPU 11 establishes a BLE communication connection with an external device to which performance data is to be transmitted (step S101). The CPU 11 acquires one packet of performance data (step S102). If the performance data is MIDI data that has been stored in the storage unit 13 in advance, the CPU 11 may divide the data range for one packet based on the timing data of each message. If the performance data is generated based on a real-time performance, the CPU 11 acquires the data within the period corresponding to one packet, i.e., the data transmission interval, as one packet of data. At this stage, the acquired MIDI data may actually exceed the maximum data size that can be transmitted in one packet.

The CPU 11 separate message data of a type in which the pitch or volume continuously change and message data of the other types (step S103). Then the CPU 11 determines whether data of the type in which the pitch or volume continuously changes is included (step S104). Examples of types in which the pitch or volume continuously changes as described above include pitch bend, aftertouch, and modulation. If it is determined that the type of data in which the pitch or volume continuously changes is not included (“NO” in step S104), the CPU 11 generates regular packet transmission data (step S112). Then, the processing of the CPU 11 shifts to step S120.

If it is determined that a message of a type in which the pitch or volume continuously changes is included (“YES” in step S104), the CPU 11 counts the amount of data for one packet data acquired in step S102, and calculate the number of messages to be removed, that is, the number exceeding the maximum number of messages that can be included in one packet (step S105).

The CPU 11 detects and deletes preferentially to-be-deleted data from the classified messages of the type in which the pitch or volume changes continuously (step S106). The preferential deletion data is, as described above, intermediate messages excluding the beginning and end when the same pitch or volume continues, for example. Then, the CPU 11 determines whether or not it is necessary to delete additional messages (step S107). The CPU 11 subtracts the number of messages deleted in step S106 from the excess number of messages, and determines whether the resulting excess number is a positive value. If it is determined that no further messages need to be deleted (the excess number is zero or less) (“NO” in step S107), the CPU 11 proceeds to step S111.

If it is determined that more messages need to be deleted (the excess number is a positive value) (“YES” in step S107), the CPU 11 applies the LPF to the pitch or volume array of each message. Then, the amount of change (speed) is calculated from the difference between adjacent pitches or volumes (step S108). The CPU 11 may also calculate the acceleration of pitch/volume change as described above. The CPU 11 identifies messages corresponding to the characteristic points based on the calculated amount of change (step S109). Each such identified message may have a flag set to that effect. The processing of step S104 (if “YES”) and step S109 constitute the detection step of this embodiment.

The CPU 11 deletes messages of the required deletion number or more from the remaining messages except for the specified characteristic message (step S110). As described above, the CPU 11 determines messages to be deleted by distributing them so that the timing of the messages to be deleted is not biased. The CPU 11 may set the maximum number of data that can be deleted based on the number of pieces of data that remain to be deleted at the stage of step S107 and that are of a type in which the pitch or volume changes continuously. If the number of deletions is greater than the maximum number of deletions, the CPU 11 may delete the maximum number of messages that can be deleted. Then, the processing of the CPU 11 moves to step S111.

At step S111, the CPU 11 generates packet data for transmission based on the remaining (without being deleted) data of a type in which the pitch or volume continuously changes and data of other types (step S111; generating step). Then, the processing of the CPU 11 moves to step S120.

At step S120, the CPU 11 waits until the transmission interval elapses from the previous data transmission, and transmits the generated packet data to the external device at the timing when the transmission interval elapses (step S120). Then, the processing of CPU 11 returns to step S102.

As described above, according to the performance data transmission control method of the present embodiment, when the computer (one or more processors) of the electronic device 1 is provided with continuously varying operation data whose value changes continuously in the performance data (MIDI data) associated with the output timing information, the computer performs a detecting step (steps S104 and S109) for detecting characteristic points of change from the continuously varying operation data; and a generation step (step S111) of generating unit performance data, which is performance data including continuously varying operation data of the detected characteristic point of change, to be transmitted to an external device based on the performance data from which the continuously varying operation data other than the characteristic points of change have been thinned out.

That is, in this detection step, the importance of each piece of data is determined by looking at the entire continuously varying operation data relating to continuous changes in pitch or the like in the packet data. As a result, relatively important data is determined not to be thinned out (removed). Therefore, in this performance data transmission method, deterioration in performance quality due to MIDI data transmitted after thinning is suppressed. That is, in the generation step, it is possible to determine suitably thinned data in units of packets by using the characteristics of packet transmission. Therefore, this performance data transmission control method can more appropriately reduce the amount of transmission data.

Further, the characteristic points to be preferentially retained may include points where continuously varying operation data including pitch data or volume data whose values change continuously take extreme values. In other words, by securely retaining messages with peak pitches (volumes), it is possible to suppress the occurrence of extremely unnatural situations, such as continuous pitch (volume) changes being wrap around or failing to reach the final pitch (volume).

In addition, the characteristic points to be preferentially retained may include inflection points of the speed change of continuously varying operation data that includes pitch data or volume data whose value changes continuously, that is, points at which the accelerations of pitch change (volume change) are zero. In other words, by leaving a message at the middle point of the pitch change and volume change, which is the part where the pitch and volume change (both rising and falling) is the largest, it is possible to suppress abrupt changes in pitch or volume, and the continuous change is more clearly maintained.

Further, in the generation step (step S111), among the messages related to continuous pitch or volume changes, points where the amount of change in pitch (volume) is below a prescribed threshold (no significant change) may be preferentially thinned out. When data is thinned where there is no change in pitch (volume), it does not affect the output pitch (volume). Therefore, in this performance data transmission control process, the amount of data can be efficiently reduced by preferentially thinning out such data that does not affect the resulting sound quality.

In addition, in the generation step, the thinning rate for the continuously varying operation data may be performed at differing rates that are determined for respective sections according to the change state of the continuously varying operation data including pitch data or volume data whose values change continuously. That is, in portions where the pitch changes won't be deteriorated significantly with a high thinning rate, the thinning rate may be set high, and in portions where the pitch changes tend to be deteriorated significantly with a high thinning rate, the thinning rate may be set low. By applying differing thinning rates to appropriately divided sections having varying volume/pitch changes, the performance data transmission control method can reduce the amount of data for transmission while maintaining high sound quality.

Also, the size of each packet data is equal to or smaller than the maximum data size of data that can be transmitted at each timing. In the detection step, characteristic points of change in volume or sound quality are detected for each data transmitted at each timing.

As a result, in the performance data transmission control method of the present embodiment, the performance data can be processed almost in real time to generate and transmit packet data without delay.

Also, by installing and executing the program 131 of the present embodiment in a computer, the processing related to the above performance data transmission control method can be easily implemented by software. Therefore, according to the program 131, using the computer, it is possible to easily and appropriately reduce the data capacity while transmitting the performance data relating to the performance to the external device.

The electronic device 1 of this embodiment includes the communication unit 14 and at least one CPU 11. If the performance data (MIDI data) associated with the output timing information includes continuously varying operation data whose value changes continuously, the CPU 11 detects the characteristic points of change from the continuously varying operation data. The CPU 11 transmits the performance data to the external device based on the performance data including the continuously varying operation data of the detected characteristic points of change and from which the continuously varying operation data other than the characteristic points of change is thinned out, so as to generate unit performance data. According to the electronic device 1, by detecting data of high importance and thinning out the data so as to retain them, deterioration of performance quality due to MIDI data transmitted by the thinning is suppressed. That is, the electronic device 1 can use the characteristics of packet transmission to determine suitable thinned data for each packet. Therefore, the electronic device 1 can more appropriately reduce the amount of transmission data in transmitting the packet data.

Further, the electronic device 1 may be an electronic musical instrument including a keyboard device K (keyboard Ke). The electronic device 1 may acquire performance data associated with output timing information in response to operations of performance operators such as the keyboard Ke, and generates unit performance data to be transmitted to the external device as described above.

With such an electronic musical instrument, it is possible to transmit the performance data of the content of the performance to the external device without delay while suppressing the deterioration of the sound quality. Therefore, it can be easily used by an external device without connecting a wired cable or the like.

It should be noted that the present invention is not limited to the above embodiments, and various modifications are possible. For example, continuous changes in values such as pitch may be generated by methods other than those described above. For example, the MIDI data my include minute pitch changes directly input by MIDI software by a user, and such minute pitch changes may be detected and thinned out within the possible range in the manner described above.

Also, continuous value changes are not limited to for pitch and/or volume. For example, continuous value changes may include continuous changes in timbre in modulation.

In addition, vibrato and trill, which repeat the same variation in a short period, may be excluded from the category of the continuously changing data to be thinned out.

Further, in the above embodiment, packet data is transmitted at intervals of 15 milliseconds using BLE, but the present invention is not limited to this. Any communication standard may be used as long as it sends a plurality of messages collectively at appropriate intervals. Also, the communication interval may not be constant.

Also, the characteristic sounds (characteristic points) are not limited to those described above. Those points identifiable as being important by any analysis algorithm can be set as points not to be thinned out.

Further, it is not necessary to specify the extreme value after applying the LPF as in the above embodiment. Further, for example, if there are a plurality of characteristic point candidates within the amplitude range for several cycles of the assumed noise, a single point among them may be determined as the feature point.

Also, the upper limit of the thinning rate may not need to be set.

Further, extraction of characteristic points related to the thinning process does not have to be performed in units of packets. In particular, when performance data is not transmitted in accordance with a real-time performance, characteristic points may be extracted in advance from the entire performance data.

According to the embodiments of the present invention, it becomes possible to obviate the problems in the conventional art where uniform thinning is performed, such as the performance deteriorating due to important sound information for performance being lost and the performance deviating from the original expression and nuance. Also, the amount of transmission data can be reduced more appropriately.

Further, in the above description, the computer-readable medium for storing the program 131 related to the audio output control of the present invention is described as an example of the storage unit 13 made up of a non-volatile memory such as a flash memory. But the present invention is not limited thereto. As other computer-readable media, it is possible to apply other non-volatile memories such as MRAM, HDDs (Hard Disk Drives), portable recording media such as CD-ROMs and DVD disks. A carrier wave is also applied to the present invention as a medium for providing program data according to the present invention via a communication line.

In addition, the specific configurations, contents and procedures of processing operations, etc., described in the above embodiments can be changed as appropriate without departing from the spirit of the present invention. The scope of the present invention includes the scope of the invention described in the claims and the scope of equivalents thereof.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A method for performance data transmission control executed by one or more processors, the method comprising, via the one or more processors:
receiving performance data associated with output timings, the performance data including continuously varying operation data whose value changes continuously;
detecting characteristic points of change from the continuously varying operation data;
thinning out the continuously varying operation data other than the characteristic points of the change; and
generating unit performance data to be transmitted to an external device, based on the performance data in which the characteristic points in the continuously varying operation data have been detected and in which the continuously varying operation data other than the characteristic points have been thinned out.

2. The method according to claim 1, wherein continuously varying operation data includes pitch data or volume data whose value changes continuously.

3. The method according to claim 2, wherein the characteristic points include a point at which the continuously varying operation data take an extreme value.

4. The method according to claim 2, wherein the characteristic points include an inflection point of change of the continuously varying operation data.

5. The method according to claim 2, wherein in thinning out the continuously varying operation data, data whose amount of change is equal to or less than a prescribed threshold is preferentially removed.

6. The method according to claim 2, wherein when the continuously varying operation data includes a plurality of sections respectively having differing states in the value change, in thinning out the continuously varying operation data, a rate of thinning out is determined for each of the plurality of sections according to the state in the value change in the section.

7. The method according to claim 1,
wherein a size of the unit performance data is equal to or smaller than a maximum data size of data that can be transmitted at each transmission timing, and
wherein the characteristic points of change are detected for each of the unit performance data to be transmitted at a corresponding transmission timing.

8. A non-transitory computer-readable storage medium storing a program executable by one or more processors, the program causing the one or more processors to perform the following:
receiving performance data associated with output timings, the performance data including continuously varying operation data whose value changes continuously;
detecting characteristic points of change from the continuously varying operation data;
thinning out the continuously varying operation data other than the characteristic points of the change; and
generating unit performance data to be transmitted to an external device, based on the performance data in which the characteristic points in the continuously varying operation data have been detected and in which the continuously varying operation data other than the characteristic points have been thinned out.

9. An electronic device, comprising:
a transmission unit; and
at least one processor configured to perform the following:
receiving performance data associated with output timings, the performance data including continuously varying operation data whose value changes continuously;
detecting characteristic points of change from the continuously varying operation data;
thinning out the continuously varying operation data other than the characteristic points of the change; and
generating unit performance data to be transmitted through by the transmission unit to an external device, based on the performance data in which the characteristic points in the continuously varying operation data have been detected and in which the continuously varying operation data other than the characteristic points have been thinned out.

10. The electronic device according to claim 9, wherein continuously varying operation data includes pitch data or volume data whose value changes continuously.

11. The electronic device according to claim 10, wherein the characteristic points include a point at which the continuously varying operation data take an extreme value.

12. The electronic device according to claim 10, wherein the characteristic points include an inflection point of change of the continuously varying operation data.

13. The electronic device according to claim 10, wherein in thinning out the continuously varying operation data, data whose amount of change is equal to or less than a prescribed threshold is preferentially removed.

14. The electronic device according to claim 10, wherein when the continuously varying operation data includes a plurality of sections respectively having differing states in the value change, in thinning out the continuously varying operation data, a rate of thinning out is determined for each of the plurality of sections according to the state in the value change in the section.

15. The electronic device according to claim 9,
wherein a size of the unit performance data is equal to or smaller than a maximum data size of data that can be transmitted at each transmission timing, and
wherein the characteristic points of change are detected for each of the unit performance data to be transmitted at a corresponding transmission timing.

16. An electronic musical instrument, comprising:
the electronic device as set forth in claim 9; and
performance operators connected to the electronic device.
